(19) United States
(12) Patent Application Publication
(10) Pub. No.: US 2017/0129665 A1
(43) Pub. Date: May 11, 2017

(54) POD SHAKER BOTTLE WITH LID

(71) Applicant: Patrick J. Rolfes, Corona Del Mar, CA (US)

(72) Inventor: Patrick J. Rolfes, Corona Del Mar, CA (US)

(21) Appl. No.: 14/757,012

(22) Filed: Nov. 9, 2015

(51) Int. Cl. B65D 51/28; B65D 1/02; B65D 47/08; A47J 43/27

(52) U.S. Cl. CPC B65D 51/2821; A47J 43/27; B65D 1/0246; B65D 47/0857

(57) ABSTRACT

A shaker bottle with a lid containing a pod sealed capsule for mixing a health beverage consists of a cylindrical shaker bottle with a lid cover attached to the bottle. The lid cover incorporates, a circumferential flange, a pod sealed capsule receptacle including an inner pod sealed capsule cutter, and a spout extending from the lid cover. A pod sealed capsule retaining cap with mating internal connectors interface with the pod sealed capsule receptacle. The pod sealed capsule retaining cap has external connectors and cap yoke arms each including a recessed stopper socket. An outlet spout stopper interfaces with the yoke arm sockets, such that when a liquid is placed in the bottle, the lid cover is screwed on, a pod sealed capsule is positioned upside down in the receptacle and manually depressed, the cap is connected to the lid cover by rotating, the pod sealing capsule is simultaneously cut open and when the bottle is manually agitated a health beverage is produced.

### TECHNICAL FIELD

The present invention relates to a shaker bottle in general. More specifically to a shaker bottle with a lid, utilizing a pre-packaged drink pod sealed capsule having mixer ingredients perfunctorily introduced with a liquid in the bottle for emulsifying a health beverage when manual shaken.

### BACKGROUND OF THE INVENTION

Previously, many types of shaker bottles with lids, or only lids, have been used in endeavoring to provide an effective means to create a mixed beverage in the bottle. However what was not found was the combination of a bottle having a lid containing a pod which incorporates a media for mixing the beverage.

The prior art listed below did not disclose patents that possess any of the novelty of the instant invention; however the following U.S. patents and patent application publications are considered related:

| Pat. No. | Inventor | Issue Date |
|---|---|---|
| 5,499,736 | Kohl | Mar. 19, 1996 |
| 6,379,032 B1 | Sorensen | Apr. 30, 2002 |
| D510,235 S | Sorensen | Oct. 4, 2005 |
| D626,837 S | Myers et al. | Nov. 9, 2010 |
| 8,342,349 B2 | Lu | Jan. 1, 2013 |
| 8,522,669 B1 | Rofles et al. | Sep. 3, 2013 |
| 8,695,830 B2 | Myers et al. | Apr. 15, 2014 |
| 8,770,096 B2 | Vanni | Jul. 8, 2014 |
| 2015/0136772 A1 | Sorensen et al. | May 21, 2015 |
| 2015/0201774 A1 | Sorensen et al. | May 23, 2015 |

Sorensen in U.S. Pat. No. 6,379,032 B1 teaches an agitator with a wire frame object with interstitial spaces allowing flow of liquids and powder into and out of the object. Other embodiments utilize and interior agitator placed within the wire frame which may be solid or a second wire frame object.

Sorensen's design Pat. No. D510,235 S is for the outline of a bottle which is presently marketed under the trademark name Blender Bottle® and is described as a shaker for a beverage.

Design Pat. No. D626,837 issued to Myers et al. provides a bottle closure with a flip top.

Lu in U.S. Pat. No. 8,342,349 B2 discloses a container assembly with two or more containers each having a coupling portion to attach one to another. The container assembly provides flexibility for a user to store and transport a variety of consumable products.

U.S. Pat. No. 8,522,669 B1 of Rofles et al. relates to a holder for a pod used for brewing a single cup beverage with heated water. The invention utilizes a holder body having an open top with an egress hole in the bottom and an ejector pin positioned in the hole. A body inner cup, with an opening in the bottom is positioned in the holder. A lid is attached to the holder and heated water is poured into the lid through the pod.

Myers et al. in U.S. Pat. No. 8,695,830 B2 teaches a container lid for sealing an opening in a container which includes a handle and a flip top, each independently pivotal along the same axis. The handle is secured between a mount on the lid and the flip top. The handle supports the weight of the container and is independently rotatable relative to the flip top.

U.S. Pat. No. 8,770,096 B2 of Vanni discloses a cartridge holder assembly with a cup shaped body adapted to receive a cartridge or a pod. A lower duct is in communication with an upper receptacle to convey a beverage to a collection container. A control device regulates the flow of the beverage.

Patent application publication No. 2015/0136772 A1 issued to Sorensen et al. is for a liquid container closure with a latching assembly. A push button latching assembly is pivotally coupled to the closure and is movable between a first position in which the outlet opening is covered by the assembly and a second position is exposed.

Sorensen et al. in U.S. patent application publication 2015/0201774 A1 discloses a lid with a first opening providing a pathway to a fluid, a second opening provides a second fluid pathway. A spout is positioned over the openings and a conduit, such as a straw, is coupled to an opening in the lid and a closure is connected to the lid for selectively closing one or more of the openings.

For background purposes and as indicative of the art to which the invention is related reference may be made to the remaining cited U.S. Pat. No. 5,499,736 issued to Kohl for a reclosable removable cap for reusable shaker dispenser bottle

### BRIEF SUMMARY OF THE INVENTION

Fundamentally the use of a bottle with a lid containing a powder or liquid media added to a fluid and agitated to mix the ingredients together has been used since the advent of a lid or leak tight enclosure on the container. Liquid shakers, in one form or another, have been used for centuries even dating back to the Egyptians where they added spices to a liquid to form a beverage. In this country innkeepers used two tumblers, having different diameter mouths, one on top of the other to shake and mix drinks. One innovative inventor as early as 1872 patented a device having a number of cups, used as upper covers, and sockets to retain the tumblers beneath, permitting a number of drinks to be mixed simultaneously. Shortly thereafter many patents begin to be issued for shakers in various shapes and configurations, all having at least a liquid container and some type of a cover or cap.

The use of a pod sealed capsule for holding a media, particularly in the hot beverage industry, has been commonly employed for many years. The term pod is a vessel for a dry legume and a capsule is a container for holding a substance. In this case a pod sealed capsule is a cup having a sealed cover on a flat flanged top with cone shaped sides and a flat recessed bottom filled with a health beverage media.

The primary object of the invention is the convenience and safety in the use of a packaged single-cup pod mixing the contents into a liquid. Customarily a powder or liquid additive is manually measured and dispense into the liquid that has been previously poured into the container. It is feasible to use too much or too little additive media to achieve a desired consistency in the beverage when mixed. To overcome this difficulty a pod sealed capsule containing an accurately pre-measured amount of media is utilized which is safe, reliable and dependable.

An important aspect of the invention is the freshness of media within the pod sealed capsule as it has been hermetically sealed at the factory and is not subject to contamination or environmental humidity. With the present invention the media is immediately mixed into a liquid as the release is accomplished within the capped bottle therefore it is completely unaffected by the prevailing ambient atmosphere conditions.

Another attribute of the invention the ease of use, as the liquid poured into a bottle, may be any fluid applicable to the finished product, such as water, fruit juice, milk, vegetable juice, coffee, tea, flavored sugar-free water, carbonated soda etc. A lid cover is screwed onto the bottle; a pod sealed capsule is positioned upside down partially into a receptacle which is integrally formed within the lid cover. A cap is placed over the lid cover, arrow indicia are aligned, and the cap is manually depressed until seated and then rotated. This action slits open the top of the pod sealing capsule permitting the media within the capsule to descend into the fluid. At that point the bottle is manually agitated, a stopper is snapped open and a blended health beverage may be poured or sipped directly from a spout on the lid cover.

Still another feature of the invention is in its simplicity as only five major parts are required. Basically it is a bottle with a lid attached, using conventional screw threads, and the lid cover includes a pod sealed capsule receptacle which incorporates a sharp pod cutter in the center. A pod sealed capsule retaining cap is connected to the pod sealed capsule receptacle with mating connectors, preferably cam-lock tabs, restricting the rotation. The pod sealed capsule retaining cap includes a spout stopper that is hinged to snap-into a spout on the lid cover. The above parts are all injected molded and interface with each other when assembled further individual parts may be easily removed by the user for cleaning.

Yet another feature of the invention realizes potential wide usage throughout this country as it benefits the users of the concentrate in a beverage to overcome personal dehydration when exercising. The fitness workout gym industry and the sports industry, as an example, utilize pre-workout concentrate mix, post-workout concentrate mix and predominantly the beverage to overcome dehydrating and added electrolytes. The health industry is helped using powder concentrates such as protein powder, weight loss powder etc. The travel industry may utilize the invention using powders or concentrates that are packaged individually for easy to transportation. The outdoor industry is benefitted as ingredients may be pre-packaged and carried on a person without difficulty.

A further aspect of the invention is its portability, instead of a large container of the liquid or powder containing a scoop or measuring cup, the exact amount of media may be carried and used without unnecessary weight or bulk.

A final attribute of the invention is its relative low ultimate cost as the bottle and lid may be continually reused and the initial cost outlay amortized over a lifetime. A shaker bottle and its top cover are individually inexpensive due to their manufacture using the injection molding process and automated production techniques. The media in all its forms may be purchased in bulk reducing the individual pod sealed capsule cost to a minimum. For convenience of the user the pod sealed capsule cartridge is sized to specifically contain the equivalent of one scoop of protein powder which eliminates the use of a measuring scoop entirely relative the popular large container presently retailed with the protein powder.

### BRIEF DESCRIPTION OF THE SEVERAL VIEWS OF THE DRAWING

FIG. 1 is a partial isometric view of the pod lid attached to a shaker bottle in the preferred embodiment.

FIG. 2 is a cutaway isometric view of the lid cover in the preferred embodiment.

FIG. 3 is a top view of the lid cover in the preferred embodiment.

FIG. 4 is a left side elevation view of the lid cover in the preferred embodiment.

FIG. 5 is a front elevation view of the lid cover in the preferred embodiment.

FIG. 6 is a right side elevation view of the lid cover in the preferred embodiment.

FIG. 7 is a top cut away isometric view of the lid cover in the preferred embodiment.

FIG. 8 is a bottom view of the lid cover in the preferred embodiment.

FIG. 9 is a cut away partial isometric side view of the lid cover in the preferred embodiment.

FIG. 10 is a cut away partial isometric view of the pod sealed capsule retaining cap in the preferred embodiment.

FIG. 11 is a top view of the pod sealed capsule retaining cap in the preferred embodiment.

FIG. 12 is a left side elevation view of the pod sealed capsule retaining cap in the preferred embodiment.

FIG. 13 is a front elevation view of the pod sealed capsule retaining cap in the preferred embodiment.

FIG. 14 is a right side elevation view of the pod retaining cap in the preferred embodiment.

FIG. 15 is a bottom view of the pod retaining cap in the preferred embodiment.

FIG. 16 is a partial isometric view of the outlet spout stopper in the preferred embodiment.

FIG. 17 is a top view of the outlet spout stopper in the preferred embodiment.

FIG. 18 is a left side elevation view of the outlet spout stopper in the preferred embodiment.

FIG. 19 is a front elevation view of the outlet spout stopper in the preferred embodiment.

FIG. 20 is a right side elevation view of the outlet spout stopper in the preferred embodiment.

FIG. 21 is a bottom view of the outlet spout stopper in the preferred embodiment.

FIG. 22 is an exploded view of the pod shaker bottle lid only with the bottle not shown in the preferred embodiment.

FIG. 23 is an isometric view of the shaker bottle in the preferred embodiment for attachment to a pod shaker bottle lid.

FIG. 24 is an isometric view of the pod sealed capsule in the preferred embodiment.

FIG. 25 is an isometric view of the underside of the pod sealed capsule retaining cap in the second embodiment.

FIG. 26 is a bottom view of the pod sealed capsule retaining cap in the second embodiment.

FIG. 27 is an isometric view of the pod sealed capsule, turned upside down, in the second embodiment.

FIG. 28 is a cross-sectional view of the pod sealed capsule, turned upside down, in the second embodiment.

### DETAILED DESCRIPTION OF THE INVENTION

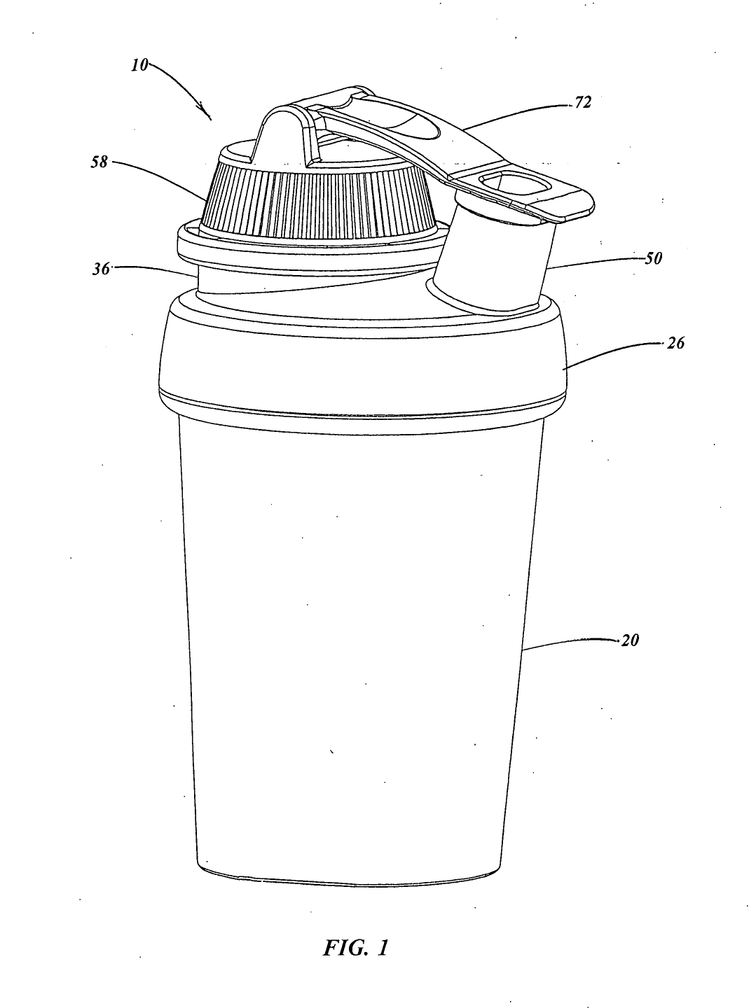

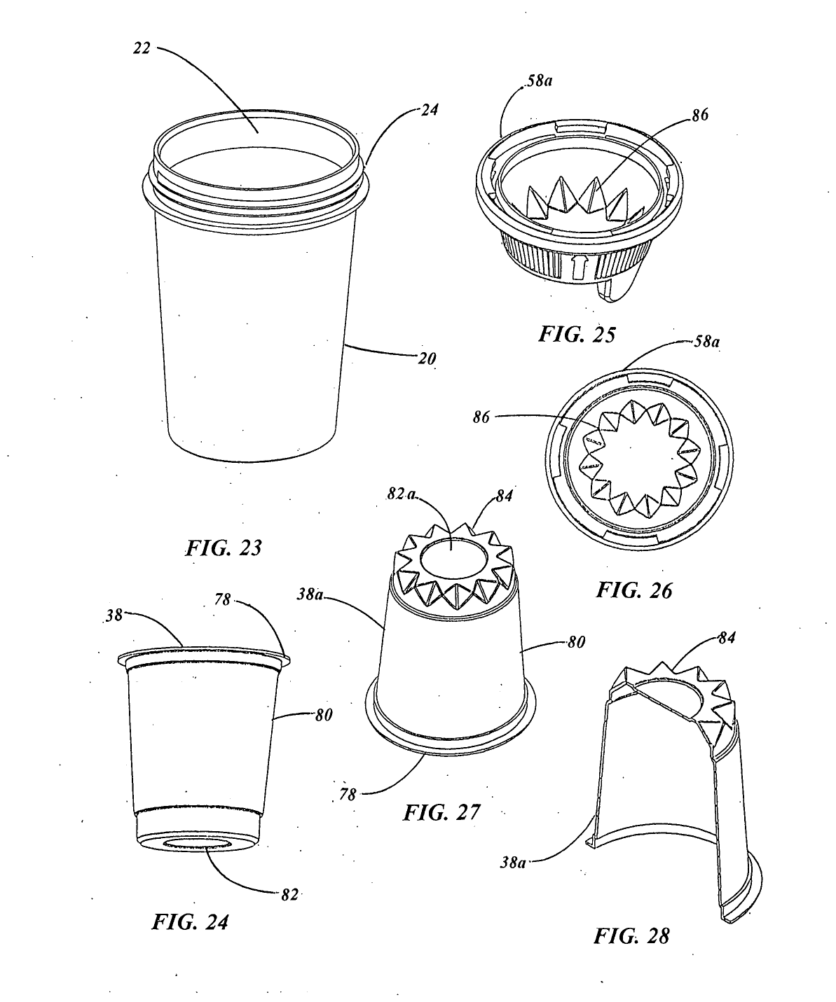

The best mode for carrying out the invention is presented in terms of a preferred and a second embodiment. The preferred embodiment is shown in FIGS. 1 thorough 22 and is comprised of a shaker bottle 20 which is cylindrical in shape and has an open top 22 with neck male threads 24, as illustrated in FIG. 23. The shaker bottle 20 may optionally be transparent, translucent or opaque to the sight, further a decorative design may include exterior indicia or a textured non-slip surface.

A pod shaker bottle lid 10 incorporates a lid cover 26 which is attached onto the shaker bottle 20 and contains an integral downwardly extending circumferential flange 28 with female threads 30 on an interior surface for mating with the bottle neck male threads 24. The lid cover circumferential flange 28 contains a flat muted surface 32 on an exterior portion. The lid cover 26 has an integral flat inwardly facing inner ring 34 that is connected to the bottle open top 22 creating a leak tight seal with the shaker bottle 20.

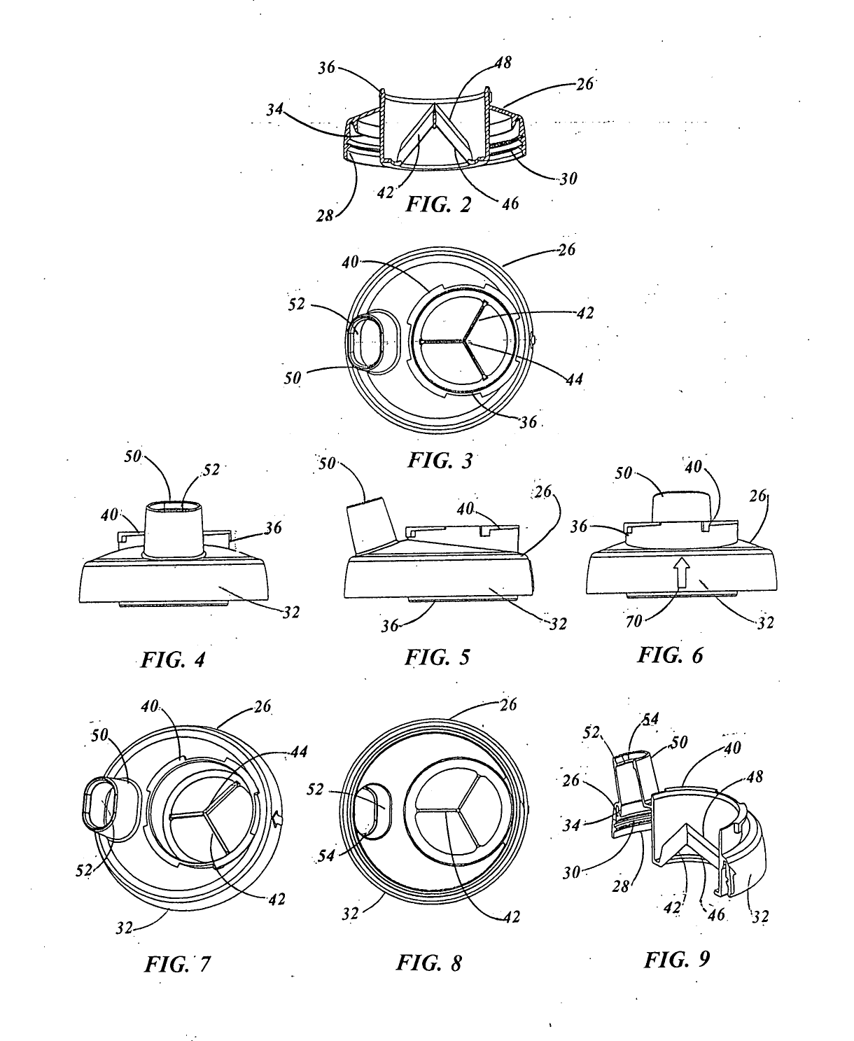

The lid cover 26 includes an integral pod sealed capsule receptacle 36 extending above and beneath the lid cover 26 for receiving the pod sealed capsule 38, as depicted in. FIGS. 2 and 4-6. The lid cover 26 includes a number of external connectors 40 preferably in the form of mating ramped interlocking tabs that outwardly extend on the top surface of the pod sealed capsule receptacle 36, illustrated in FIGS. 3-6, 7 and 9 or threads or any other means for joining objects together.

The lid cover 26 has a pod sealed capsule cutter 42 inside the pod sealed capsule receptacle 36 which incorporates a sharp intersecting apex 44 for slicing open a top cover of a pod sealed capsule 38. The pod sealed capsule cutter 42 incorporates a number of integral parallelogram shaped cutter members 46 each converging at the intersecting apex 44, with each pod cutter member 46 tapered to a severe sharp edge 48 on an upward positioned portion, depicted in FIGS. 2, 3 and 7-9. Each cutter member is radiused integrally to interface with an inside portion of the pod sealed capsule receptacle 36 as shown in FIG. 8. The integral pod sealed capsule receptacle 36 is essentially a vertical cylinder sufficiently sized to self-center the pod sealed capsule 38 on the pod sealed capsule cutters intersecting apex 44.

The lid cover 26 incorporates an integral spout 50 extending upwardly at a slight outward angle and is tapered inwardly from the top surface of the lid cover 26. The spout 50 includes an inner passageway 52 completely through the lid cover 26 and contains an internal bead 54 on an inner distal end of the inner passageway 52, illustrated in FIGS. 7-9, permitting a snap-in interface connection.

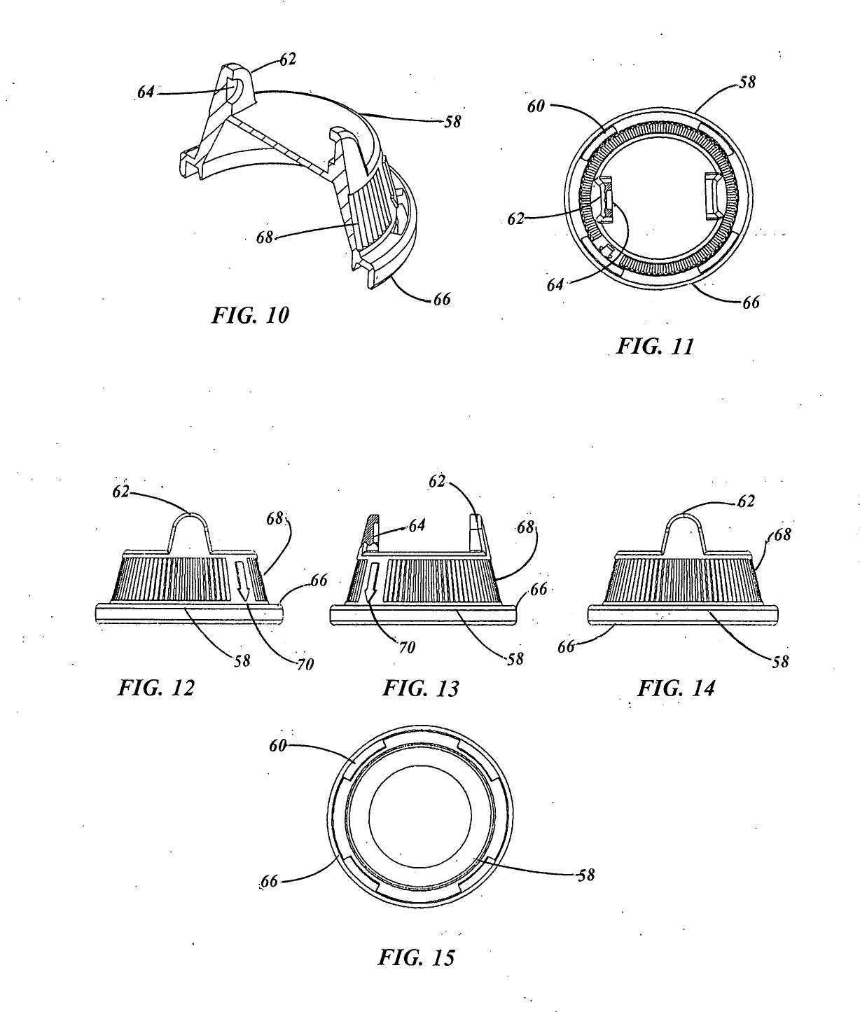

A pod sealed capsule retaining cap 58 with mating internal connectors 60 interfaces with the pod sealed capsule receptacle 36, as depicted in FIGS. 10-15. The pod sealed capsule retaining cap 58 includes upwardly extending yoke arms 62 integral with a top surface of the pod retaining cap 58 with each yoke arm 62 having a recessed stopper socket 64, as illustrated in FIGS. 10, 11 and 13. The pod sealed capsule retaining cap 58 further has an outwardly facing extending ring 66 containing the mating internal connectors 60 which are preferably a plurality of mating ramped interlocking tabs. The pod sealed capsule retaining cap 58 has a plurality of vertical gripping grooves 68 on an outer outwardly facing sloped surface.

The lid cover 26 and pod sealed capsule retaining cap 58 each incorporate an indicia arrow 70, depicted in FIGS. 6, 12, and 13, pointing at each other on adjoining surfaces for alignment of the pod retaining cap to the cover prior to manually rotating the lid cover.

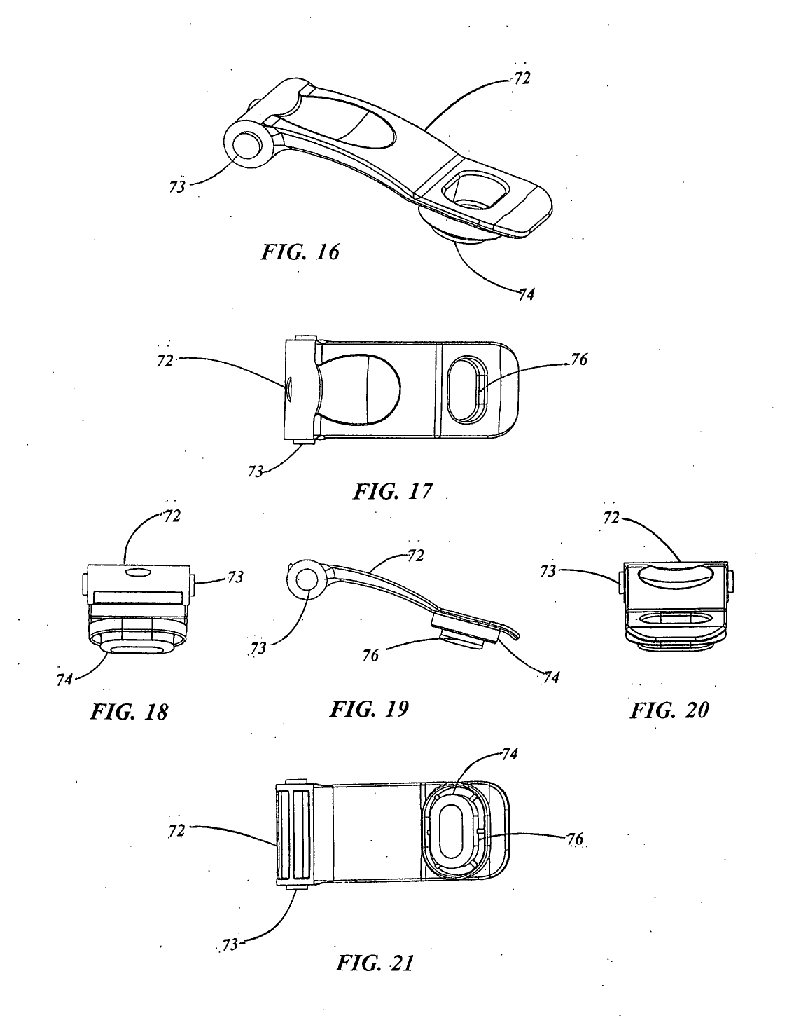

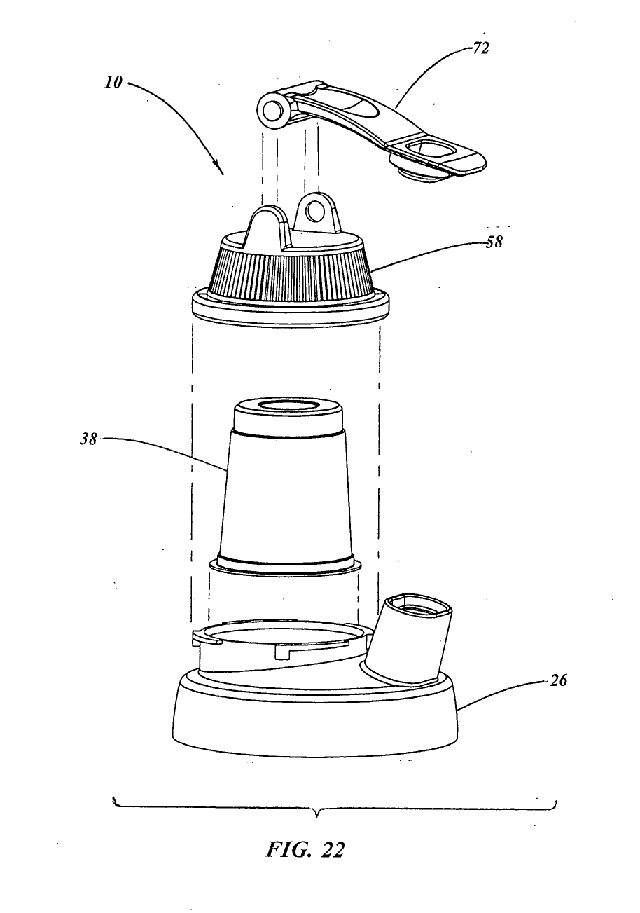

An outlet spout stopper 72, shown in FIGS. 16-21, includes a circular outwardly extending boss 73 on each horizontal axis for interfacing with the yoke arm stopper sockets 64. The outlet spout stopper 72 has a round flat plug 74, which includes a plug bead 76, on an underside surface of the stopper 72, as illustrated best in FIG. 19, permitting the stopper distal end to be snapped into the spout 50.

The pod shaker bottle lid 10 functions as follows; a liquid is placed in the shaker bottle 20, the lid cover 26 is screwed on the shaker bottle 20, the pod sealed capsule 38 is positioned upside down into the pod sealed capsule receptacle 36, the pod sealed capsule retaining cap 58 is placed over the lid cover 26, and manually depressed then rotated a slitting open the flat sealed flanged top 78 of the pod sealing capsule 38, the bottle 20 is manually agitated producing a health beverage.

The pod sealed capsule 38 consists of a flat sealed flanged top 78, cone shaped sides 80 and a flat recessed bottom 82, with the pod sealed capsule 38 preferably sized to contain the equivalent of one scoop of health beverage media which may be, but is not limited to, protein power, weight loss powder, beverage concentrate, pre-workout concentrate mix, post-workout concentrate mix, vitamins and medication. Different sized volume displacement pod sealed capsules 38 may be used according to the requirements of the media contained within. Further said liquid placed in the bottle may consist of, but not limited to, water, fruit juice, milk, vegetable juice, coffee, tea, flavored sugar free water and carbonated soda etc.

The second embodiment is exactly the same as the preferred embodiment with the exception of added limitations within the pod sealed capsule retaining cap 58a and pod sealed capsule 38a, as illustrated in FIGS. 25-28. This appendage permits an improvement in the function of the pod cutter 42. The cap 58a incorporates a plurality of peripheral male indentations 84 and the pod sealed capsule 38a include a plurality of internal mating female indentations 86, permitting the pod sealed capsule to mate together when rotating the cap 58a, therefore making certain the a flat sealed top of the pod sealed capsule 38a is totally opened.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

### ADDENDUM

### Pod Shaker Bottle with Lid

### Element Designation

10 pod shaker bottle lid
20 shaker bottle
22 open top (of 20)
24 male threads (on 22)
26 lid cover
28 flange (on 26)
30 female threads (in 28)
32 muted surface (on 28)
34 inner ring (on 28)
36 pod sealed capsule receptacle (in 26)
38 pod sealed capsule
38a pod sealed capsule (second embodiment)
40 external connectors (on 36)
42 pod sealed capsule cutter (in 36)
44 intersecting apex (on 42)
46 cutter members (of 42)
48 sharp edges (on 46)
50 spout (on 26)
52 inner passageway (of 50)
54 internal bead (on 52)
58 pod sealed capsule retaining cap
58a pod sealed capsule retaining cap (second embodiment)
60 mating internal connector (on 58)
62 yoke arms (on 58)
64 stopper socket (in 62)
66 extending ring (on 58)
68 gripping indentations (on 58)
70 indicia arrows (on 26 and 58)
72 spout stopper
73 outwardly extending boss (on 72)
74 flat plug (on 72)
76 flat plug bead (on 74)
78 flanged top (of 38)
80 tapered sides (of 38)
82 bottom (of 38)
82a bottom (of 38a in second embodiment)
84 male indentations (in 58a second embodiment)
86 female indentations (in 38a second embodiment)

1. A shaker bottle with a lid containing a pod sealed capsule for mixing a health beverage which comprises;
said lid having a lid cover, for attachment onto said shaker bottle, said lid cover further having, an integral pod sealed capsule receptacle adapted to receive said pod sealed capsule, a plurality of external connectors on a top surface of said pod sealed capsule receptacle, a pod sealed capsule cutter inside said pod sealed capsule receptacle for slicing open said pod sealed capsule, and an integral spout extending from said lid cover,
a pod sealed capsule retaining cap having mating internal connectors for interfacing with said pod sealed capsule receptacle external connectors, said pod sealed capsule retaining cap having integral upwardly extending yoke arms, and
an outlet spout stopper interfacing with said yoke arms, such that when a liquid is placed in the shaker bottle, said pod sealed capsule lid cover is attached onto said shaker bottle, said pod sealed capsule is positioned upside down into said pod sealed capsule receptacle, said pod sealed capsule retaining cap is placed over said lid cover, manually depressed and rotated cutting open said pod sealing capsule, when the bottle is manually agitated a health beverage is produced.

2. The shaker bottle with a lid containing a pod sealed capsule as recited in claim 1 further comprises said shaker bottle having a cylindrical configuration with threads on a neck, said lid cover incorporates a circumferential flange having female threads inside for screwing onto said shaker bottle, said pod sealed capsule cutter having a sharp intersecting apex, and said pod sealed capsule retaining cap having interfacing connections with said pod sealed capsule receptacle.

3. A shaker bottle with a lid containing a pod sealed capsule for mixing a health beverage which comprises;
a) said shaker bottle is cylindrical having an open top with neck male threads,
b) a lid cover for attachment onto said bottle,
said lid cover having an integral downwardly extending circumferential flange with female threads on an interior surface for mating with said bottle neck male threads,
said lid cover having an integral pod sealed capsule receptacle adapted to receive said pod sealed capsule, extending above and beneath said lid cover,
said lid cover having a plurality of external connectors outwardly extending on a top surface of said pod sealed capsule receptacle,
said lid cover having a pod sealed capsule cutter inside said pod receptacle having a sharp intersecting apex for slicing open a top cover of said pod sealed capsule,
said lid cover having an integral spout extending upwardly from said lid cover,
c) a pod sealed capsule retaining cap with mating internal connectors for interfacing with said pod sealed capsule receptacle,
said pod sealed capsule retaining cap having upwardly extending yoke arms integral with a top surface of said pod sealed capsule retaining cap, each yoke arm having a recessed stopper socket, and
d) an outlet spout stopper having a horizontal axis with a circular boss on each side interfacing with said yoke arm recessed stopper sockets, permitting a portion of the stopper distal end to be snapped into said integral spout,
such that when a liquid is placed in said shaker bottle, said lid cover is screwed on said shaker bottle, said pod sealed capsule is positioned upside down in said pod sealed capsule retaining receptacle, said pod sealed capsule retaining cap is placed over said lid cover, manually depressed, further rotated cutting open said pod sealing capsule, and when the shaker bottle is manually agitated a health beverage is produced.

4. The shaker bottle with a lid as recited in claim 3 wherein said shaker bottle further having a facade selected from the group consisting of a decorative design, exterior indicia, and a textured non-slip surface, as well as transparent, translucent and opaque visible material.

5. The shaker bottle with a lid as recited in claim 3 wherein said lid cover further having an integral flat inwardly facing inner ring for intimately engaging said shaker bottle open top in a leak tight manner.

6. The shaker bottle with a lid as recited in claim 3 wherein said lid cover circumferential flange further having a flat muted surface on an exterior portion.

7. The shaker bottle with a lid as recited in claim 3 wherein said integral pod sealed capsule receptacle is a vertical cylinder sufficiently sized to self-center said pod sealed capsule on the pod sealed capsule cutters intersecting apex.

8. The shaker bottle with a lid as recited in claim 3 wherein said lid cover external connectors further comprise a plurality of external ramped interlocking tabs outwardly extending on a top surface of said lid cover pod sealed capsule receptacle.

9. The shaker bottle with a lid as recited in claim 3 wherein said pod sealed capsule cutter further comprising a plurality of integral parallelogram shaped cutter members each converging at said intersecting apex wherein each member is tapered to a severe sharp edge on an upward positioned portion.

10. The shaker bottle with a lid as recited in claim 9 wherein each cutter member is radiused integrally to interface with an inside portion of said pod sealed capsule receptacle.

11. The shaker bottle with a lid as recited in claim 3 wherein said spout further having an inner passageway completely through said lid cover.

12. The shaker bottle with a lid as recited in claim 3 wherein said integral spout is tapered outwardly with a bead on the inner distal end permitting a snap-in interface connection with said integral spout stopper.

13. The shaker bottle with a lid as recited in claim 3 wherein said integral pod sealed capsule retaining cap further comprises an outwardly facing extending ring containing said mating internal connectors which are defined as a plurality of mating ramped interlocking tabs.

14. The shaker bottle as with a lid recited in claim 3 wherein said pod sealed capsule retaining cap further having a plurality of vertical gripping grooves on an outer outwardly facing upper sloped surface of said retaining cap.

15. The shaker bottle with a lid as recited in claim 3 wherein said pod sealed capsule retaining cap and said lid cover each further comprise a facing indicia arrow on adjoining surfaces for alignment of said pod sealed capsule retaining cap to said lid cover prior to manually rotating the lid.

16. The shaker bottle with a lid as recited in claim 3 wherein said outlet spout stopper further having a round flat plug incorporating a plug bead on an underside surface of said outlet spout stopper.

17. The shaker bottle with a lid as recited in claim 3 wherein said pod sealed capsule further comprises a flat sealed flanged top, cone shaped sides and a flat recessed bottom, and is filled with a health beverage media selected from the group consisting of a protein powder, weight loss powder, beverage concentrate, pre-workout concentrate mix, post-workout concentrate mix, vitamins and medication, the cartridge is sized to contain the equivalent of one scoop protein powder, also said liquid placed in the shaker bottle is selected from the group consisting of water, fruit juice, milk, vegetable juice, coffee, tea, flavored sugar free water and carbonated soda.

18. The shaker bottle with a lid as recited in claim 3 further comprising said pod sealed capsule retaining cap having means for grasping said pod sealed capsule, consisting of a plurality of peripheral male external indentations and said pod sealed capsule having plurality of internal mating female indentations permitting the pod sealed capsule to mate together when rotating the pod sealed capsule retaining cap therefore completely opening a flat sealed top of said pod sealed capsule.

19. A shaker bottle with a lid containing a pod sealed capsule for mixing a health beverage which comprises;
said shaker bottle is cylindrical with a neck incorporating neck male threads,
a lid cover with internal female threads attached onto said bottle neck male threads, said lid cover having,
an integral downwardly extending circumferential flange,
an integral pod sealed capsule receptacle with external connectors adapted to receive said pod sealed capsule,
a pod sealed capsule cutter inside said pod sealed capsule receptacle for slicing open a top cover of said pod sealed capsule,
an integral spout extending upwardly from said lid cover,
a pod sealed capsule retaining cap with mating internal connectors interfacing with said pod sealed capsule receptacle,
upwardly extending yoke arms integral with said pod sealed capsule retaining cap, each yoke arm having a recessed stopper socket, and
an outlet spout stopper having circular boss interfaced with said yoke arm sockets,
such that when a liquid is placed in said shaker bottle, said lid cover is screwed on, a pod sealed capsule is positioned upside down in said pod sealed capsule receptacle, said pod sealed capsule retaining cap is placed over said lid cover and manually depressed then rotated, which simultaneously rotates said pod sealed capsule, and when the bottle is manually agitated a health beverage is produced.

20. The shaker bottle with a lid as recited in claim 19 wherein said pod sealed capsule retaining cap having means for grasping said pod sealed capsule, consisting of a plurality of peripheral male external indentations and said pod sealed capsule having plurality of internal mating female indentations permitting the pod sealed capsule to mate together when rotating the pod sealed capsule retaining cap therefore completely opening a flat sealed top of said pod sealed capsule.
